(19) United States
(12) Patent Application Publication
(10) Pub. No.: US 2025/0109457 A1
(43) Pub. Date: Apr. 3, 2025

(54) DEVICE AND METHOD FOR MAGNESIUM SMELTING BY VACUUM CARBOTHERMAL REDUCTION OF CALCINED DOLOMITE

(71) Applicant: Kunming University of Science and Technology, Kunming (CN)

(72) Inventors: Yang Tian, Kunming (CN); Tingzhuang Ma, Kunming (CN); Bin Yang, Kunming (CN); Baoqiang Xu, Kunming (CN); Wenlong Jiang, Kunming (CN); Fei Wang, Kunming (CN); Yifu Li, Kunming (CN); Lipeng Wang, Kunming (CN); Dong Liang, Kunming (CN); Rong Yu, Kunming (CN)

(21) Appl. No.: 18/979,540

(22) Filed: Dec. 12, 2024

Related U.S. Application Data
(63) Continuation of application No. PCT/CN2023/082065, filed on Mar. 17, 2023.

(30) Foreign Application Priority Data
Aug. 30, 2022 (CN) 202211055386.7

(51) Int. Cl. C22B 26/22; C22B 1/24; C22B 5/10; F27B 5/02; F27B 5/04; F27D 9/00

(52) U.S. Cl. CPC C22B 26/22; C22B 1/24; C22B 5/10; F27B 5/02; F27B 5/04; F27D 9/00; F27D 2009/0002; F27M 2003/13

(57) ABSTRACT

The present disclosure relates to the technical field of magnesium metallurgy, and in particular to a device and method for magnesium smelting by vacuum carbothermal reduction of calcined dolomite. The device includes a reaction chamber, a condensation chamber, a first temperature regulation module and an air pressure regulation module, and the reaction chamber is communicated with the condensation chamber via a gas-guide tube. In the present disclosure, different condensation zones are utilized to sequentially condense gaseous products based on dew points, effectively preventing impurities from entering the condensation process of magnesium. Additionally, based on dynamic equilibrium in the condensation process of the gaseous products within the condensation chamber, efficient condensation and collection of magnesium in the condensation zone at middle section is ensured while preventing reverse reaction between magnesium and CO in the condensation zone of magnesium, enhancing the condensation-based purification effect.

### CROSS-REFERENCE TO RELATED APPLICATIONS

This application is a continuation of PCT/CN2023/082065, filed on Mar. 17, 2023 and claims priority of Chinese Patent Application No. 202211055386.7, filed on Aug. 30, 2022, the entire contents of which are incorporated herein by reference.

### TECHNICAL FIELD

The present disclosure relates to the technical field of magnesium metallurgy, and in particular to a device and method for magnesium smelting by vacuum carbothermal reduction of calcined dolomite.

### BACKGROUND

Magnesium-based materials are known as the “green engineering materials in 21st century” and “revolutionary medical metal materials”. As the lightest structural metal applied in industries, magnesium features light weight, high specific strength, high specific stiffness, good biomechanical properties, and lower corrosion rates, making it widely applied in such fields as aerospace, military industries, nuclear energy industries, automobile industries, 3C industries, sacrificial anodes, and biomedicine. Nowadays, as industries advance rapidly, magnesium is increasingly demanded worldwide at a rate of 10% annually, and has a promising development.

Currently, Pidgeon process mainly serves as the commercial method for producing magnesium worldwide. However, the Pidgeon process has deficiencies such as high energy consumption, low production efficiency, high labor intensity, and the generation of lots of sulfur oxide and carbon oxide gases. Especially, the expensive reducing agent ferrosilicon is employed, which seriously pollutes the environment during preparation, hindering the development of this process. The vacuum carbothermal reduction method using inexpensive carbon as the reducing agent is an efficient and eco-friendly novel smelting technology, which features high efficiency, low cost of carbon as a reducing agent, minimal solid waste emissions, no slag formation, and no pollution.

In the existing vacuum carbothermal reduction technologies for magnesium smelting, the smelting method for extracting metallic magnesium by vacuum carbothermal reduction of magnesium oxide ore and coal disclosed in Chinese patent with the publication number CN1769505A involves that raw materials with a magnesium oxide mass content of 95% or more are adopted for vacuum carbothermal reduction, resulting in magnesium products with a purity of only about 90%, which severely limits the subsequent processing and application of the magnesium products.

### SUMMARY

An objective of the present application is to provide a device and method for magnesium smelting by vacuum carbothermal reduction of calcined dolomite, solving the above technical problems existing in the prior art. The following two aspects are mainly included.

A first aspect of the present application provides a device for magnesium smelting by vacuum carbothermal reduction of calcined dolomite, including a reaction chamber, a condensation chamber, a first temperature regulation module, and an air pressure regulation module. The first temperature regulation module serves for regulating a temperature within the reaction chamber, the air pressure regulation module serves for regulating an air pressure within the reaction chamber, and the reaction chamber is communicated with the condensation chamber via a gas-guide tube; and the gas-guide tube serves for controlling a flow rate of gaseous products from the reaction chamber into the condensation chamber, achieving dynamic equilibrium in the condensation process of the gaseous products within the condensation chamber, and a plurality of condensation zones sequentially communicated along the flow direction of the gaseous products are arranged inside the condensation chamber.

Further, the device includes a second temperature regulation module, the second temperature regulation module serves for regulating a temperature within the condensation chamber, and the second temperature regulation module is cooperated with the gas-guide tube to realize dynamic equilibrium in the condensation process of the gaseous products within the condensation chamber.

Further, the condensation chamber is arranged above the reaction chamber.

Further, the condensation zones in the condensation chamber are arranged longitudinally and sequentially.

Further, a thermal insulation component is arranged between the reaction chamber and the condensation chamber.

Further, the thermal insulation component is a thermal insulation shroud, and the reaction chamber is arranged inside the thermal insulation shroud.

Further, the device includes a housing, and the reaction chamber, the condensation chamber, and the thermal insulation shroud are arranged inside the housing.

Further, a plurality of baffle plates are arranged inside the condensation chamber, the baffle plates serve for partitioning the condensation chamber into multi-stage condensation zones, and condensation grooves are disposed at tops of the baffle plates.

Further, the device includes a cooling system, and the cooling system serves for cooling the reaction chamber.

A second aspect of the present disclosure provides a method for magnesium smelting by vacuum carbothermal reduction of calcined dolomite, including the following steps: mixing calcined dolomite, coking coal, and a reduction catalyst, followed by briquetting, and placing a briquetted mixture in the reaction chamber under inert gas protection and a vacuum degree below 120 Pa, followed by heat preservation reaction at 1473 K-1723 K. The gaseous products are guided into the multi-stage condensation zones within the condensation chamber during the heat preservation reaction, and the temperature of the condensation chamber is regulated to maintain at 643 K-733 K, achieving dynamic equilibrium in the condensation process of the gaseous products within the condensation chamber; and along the flow direction of the gaseous products, temperatures of the multi-stage condensation zones in the condensation chamber gradually decrease.

Further, the calcined dolomite and the coking coal are mixed at a molar ratio of MgO to C of 1:1.8, and/or, a mass percentage of sodium fluoride in the mixture is 1%-13%.

Further, the mass percentage of sodium fluoride in the mixture is 3%-13%.

Further, the mass percentage of sodium fluoride in the mixture is 5%-13%.

Further, along the flow direction of the gaseous products, temperature intervals of the multi-stage condensation zones are sequentially set at 733 K-713 K, 713 K-693 K, 693 K-673 K, and 673 K-643 K.

Further, the temperature intervals of the multi-stage condensation zones are arranged longitudinally and sequentially.

Further, the method is implemented based on the foregoing device.

Compared with the prior art, the present disclosure has at least the following technical effects.

In the present disclosure, different condensation zones are utilized to condense different components of the gaseous products sequentially based on dew points, effectively preventing impurities from entering the condensation process of magnesium. Meanwhile, based on the dynamic equilibrium in the condensation process of the gaseous products within the condensation chamber, after the gaseous products enter the condensation chamber, their different components can stably exist in corresponding condensation zones, with a markedly stable grading. The condensation zone corresponding to magnesium is located in the middle section, the condensation zone corresponding to silicon and aluminum are located at the front section, and the condensation zone corresponding to sodium, potassium, and CO is mainly concentrated at the end section. In this way, even if all gaseous products are concentrated in the condensation chamber without being guided outwards across the entire condensation process, magnesium can still be efficiently condensed and collected in the condensation zone at the middle section while preventing reverse reaction between magnesium and CO in the magnesium vapor condensation zone, further enhancing the purity of magnesium. Additionally, during the vacuum carbothermal reduction of calcined dolomite for magnesium smelting, the addition of catalyst can significantly improve the reduction degree in reaction, and the catalytic effect of sodium fluoride as a catalyst is significantly superior to that of calcium fluoride as a catalyst.

### BRIEF DESCRIPTION OF THE DRAWINGS

To state the technical solutions of the embodiments in the present disclosure clearer, the accompanying drawings needed in the description of embodiments or prior art are stated briefly below. Obviously, the drawings described below are some embodiments in the present disclosure, and for those skilled in the art, other drawings can be obtained according to these drawings without creative efforts.

FIG. 1 is a schematic structural diagram of a device for magnesium smelting by vacuum carbothermal reduction of calcined dolomite in Embodiment 1;

FIG. 2 is a front section view of the device for magnesium smelting by vacuum carbothermal reduction of calcined dolomite in Embodiment 1;

FIG. 3 is a section view of the connection structure between a condensation chamber and a reaction chamber in FIG. 1;

FIG. 4 is a flow chart of a method for magnesium smelting by vacuum carbothermal reduction of calcined dolomite in Embodiment 2;

FIG. 5 shows the X-ray diffraction (XRD) detection of residues within a reaction chamber in Embodiment 4;

FIG. 6 shows the scanning electron microscope (SEM) detection of residues within the reaction chamber in Embodiment 4;

FIG. 7 shows the XRD detection of condensed products within a third condensation zone from bottom to top in a condensation chamber in Embodiment 4;

FIG. 8 shows the SEM detection of condensed products within the third condensation zone from bottom to top in the condensation chamber in Embodiment 4;

FIG. 9 shows the SEM detection of condensed products within a fourth condensation zone from bottom to top in the condensation chamber in Embodiment 4; and

FIG. 10 shows the SEM detection of condensed products within a condensation chamber in a control experiment in Embodiment 4.

Reference numerals and denotations thereof:
10—housing; 110—temperature detection unit; 20—condensation chamber; 210—baffle plate; 220—cooling groove; 30—gas—guide tube; 40—reaction chamber; 50—thermal insulation component; 60—heat preservation layer; 70—first temperature regulation module; 80—first cooling cavity; 810—first liquid inlet; 820—first liquid outlet; 90—second cooling cavity; 910—second liquid outlet; and 920—second liquid outlet.

### DETAILED DESCRIPTION

In the following description, numerous different embodiments or examples are provided for implementing various features of the present disclosure. The elements and arrangements described in the specific examples below are intended solely to concisely express the present disclosure, and serve as examples only rather than limiting the present disclosure.

For clearer objective, technical solutions and advantages of the present disclosure, the technical solutions of the implementations in the present disclosure will be described clearly and completely by reference to the accompanying drawings of the implementations in the present disclosure below. Obviously, the implementations described are only some, rather than all implementations of the present disclosure. Based on the implementations of the present disclosure, all other implementations obtained by those ordinary skilled in the art without creative efforts are included in the scope of protection of the present disclosure. Therefore, the detailed description of the implementations of the present disclosure provided in the accompanying drawings is not intended to limit the scope claimed by the present disclosure, but merely to represent selected implementations of the present disclosure.

In the present disclosure, unless otherwise clearly specified and defined, the terms “mounted”, “connection”, “be connected to”, and “fixed” are to be understood in a broad sense. For example, the connection can be fixed connection, detachable connection, integral connection, mechanical connection, electrical connection, direct connection, indirect connection through an intermediate medium, connection between two components, or interaction between two components. For those ordinary skilled in the art, the specific meanings of the above terms in the present disclosure can be understood according to specific circumstances. In addition, the terms “first”, “second” and “third” are only used to distinguish between descriptions, not to be understood as indicating or implying relative importance.

In the present disclosure, unless other clearly specified and defined, a first feature “above” or “below” a second feature can be a direct contact between the two features, or an indirect contact through other features between them. Moreover, the first feature “on”, “above” and “at the top of” the second feature includes that the first feature is directly above the second feature and diagonally above it, or merely represents that the horizontal level of the first feature is higher than that of the second feature. The first feature “under”, “below” and “at the bottom of” the second feature includes that the first feature is directly below the second feature and diagonally below it, or merely represents that the horizontal level of the first feature is lower than that of the second feature.

### Embodiment 1

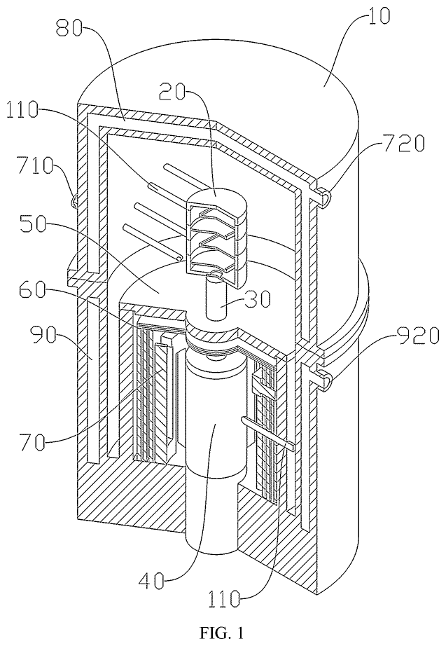

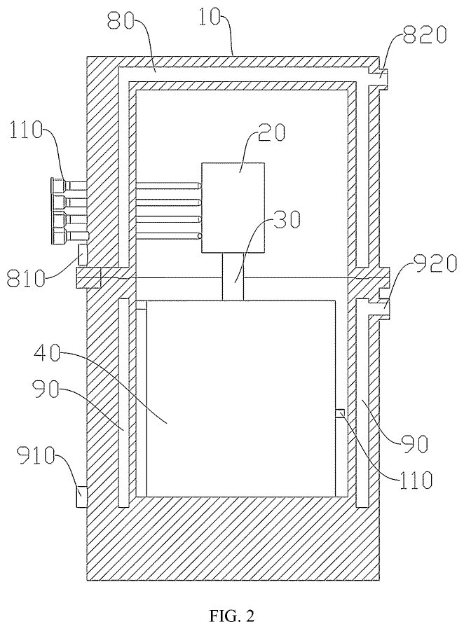

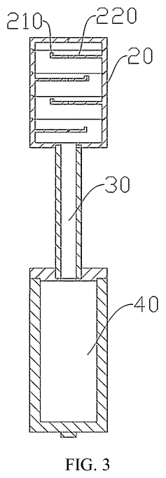

This embodiment of the present disclosure provides a device for magnesium smelting by vacuum carbothermal reduction of calcined dolomite, as shown in FIGS. 1-3, including a reaction chamber 40, a condensation chamber 20, a first temperature regulation module 70, and an air pressure regulation module. The first temperature regulation module 70 serves for regulating a temperature within the reaction chamber 40. The air pressure regulation module serves for regulating an air pressure within the reaction chamber 40. The reaction chamber 40 is communicated with the condensation chamber 20 via a gas-guide tube 30. The gas-guide tube 30 serves for controlling a flow rate of gaseous products from the reaction chamber 40 into the condensation chamber 20, achieving dynamic equilibrium in the condensation process of the gaseous products within the condensation chamber 20. A plurality of condensation zones sequentially communicated along the flow direction of the gaseous products are arranged inside the condensation chamber 20.

In the existing technologies for magnesium smelting by vacuum carbothermal reduction of calcined dolomite, a condenser is typically employed to control a condensation temperature at 600° C.-680° C. to condense the gaseous products generated during magnesium smelting by vacuum carbothermal reduction of calcined dolomite, so as to collect magnesium. However, except for magnesium vapor, the gaseous products also contain impurities such as CO, Al, Si, Na, K, etc, which will enter the condensation process of magnesium if the gaseous products are directly condensed, reducing the purity of magnesium in the condensed products. In this embodiment, a plurality of condensation zones communicated sequentially along the flow direction of gaseous products are arranged inside the condensation chamber 20, and different components of the gaseous products are condensed sequentially in different condensation zones based on dew points, effectively preventing impurities from entering the magnesium condensation process. At the same time, the gas-guide tube 30 is arranged to communicate the reaction chamber 40 with the condensation chamber 20, and the gas-guide tube 30 is utilized to control the flow rate of gaseous products entering the condensation chamber 20 from the reaction chamber 40, so that the heat brought by the newly entering gaseous products in the condensation chamber 20 balances with the heat loss of the condensation chamber 20 during condensation. This enables rapid condensation of the gaseous products upon entering the condensation chamber 20 while keeping the condensation chamber 20 at a lower and stable temperature interval, so that a continuous temperature and pressure difference exists between the condensation chamber 20 and the reaction chamber 40. Under the action of the temperature and pressure difference, the gaseous products in the reaction chamber 40 can continuously enter the condensation chamber 20, achieving a continuous and stable equilibrium between reduction reaction and condensation and collection of products, and achieving the technical effect of improving product purity. Additionally, based on the dynamic equilibrium in the condensation process of the gaseous products within the condensation chamber 20, after the gaseous products enter the condensation chamber 20, their different components can stably exist in corresponding condensation zones, with a markedly stable grading. The condensation zone corresponding to magnesium is located in the middle section, the condensation zone corresponding to silicon and aluminum is located at the front section, and the condensation zone corresponding to sodium, potassium, and CO is mainly concentrated at the end section. In this way, even if all gaseous products are concentrated in the condensation chamber 20 without being guided outwards across the entire condensation process, magnesium can still be efficiently condensed and collected in the condensation zone at the middle section while preventing reverse reaction between magnesium and CO in the magnesium vapor condensation zone, further enhancing the purity of the product crystallized magnesium.

Specifically, the device also includes a second temperature regulation module. The second temperature regulation module serves for regulating a temperature within the condensation chamber 20, and the second temperature regulation module is cooperated with the gas-guide tube 30 to realize dynamic equilibrium in the condensation process of the gaseous products within the condensation chamber 20.

To prevent condensation of gaseous products within the gas-guide tube 30, the length of the gas-guide tube 30 requires to be controlled without adding additional heat preservation devices to the gas-guide tube 30, and the reaction chamber 40 and the condensation chamber 20 need to be arranged adjacent to each other. Therefore, the heat generated under high-temperature reaction conditions in the reaction chamber 40 will affect the temperature of the condensation chamber 20. To ensure the dynamic equilibrium in the condensation process of the gaseous products within the condensation chamber 20, the second temperature regulation module is employed to regulate the temperature of the condensation chamber 20, preventing the heat radiation of the reaction chamber 40 from disrupting the equilibrium within the condensation chamber 20. Meanwhile, the second temperature regulation module is cooperated with the gas-guide tube 30 to achieve the dynamic equilibrium in the condensation process of the gaseous products within the condensation chamber 20, and the temperature fluctuation within the condensation chamber 20 is further limited and narrowed, ensuring a continuous and stable condensation and purification process within the condensation chamber 20.

Specifically, the condensation chamber 20 is arranged above the reaction chamber 40. In this way, the gaseous products within the reaction chamber 40 will automatically flow through the gas-guide tube 30 into the condensation chamber 20 according to the principle of hot air rising, requiring no additional power sources. This achieves the transfer of gaseous products towards the condensation chamber 20 by a power-free automatic traction. The structure of the device is simplified and the convenience of using the device is improved.

Specifically, the condensation zones in the condensation chamber 20 are arranged longitudinally and sequentially. In this way, the output port of the gas-guide tube 30 is located at the bottom of the condensation chamber 20, so that the gaseous products flow from bottom to top, and the heat radiation from the reaction chamber 40 and the thermal energy carried by the gaseous products gradually decrease from bottom to top, enabling an automatic gradual decrease in temperature intervals across the condensation zones from bottom to top, and requiring no additional sorting of the gaseous products. Upon entering the condensation chamber 20, the gaseous products sequentially pass through condensation zones with gradually decreased temperatures, and their different components automatically condense in the condensation zones corresponding to the temperature intervals, achieving power-free automatic condensation and purification of magnesium. The structure of the device is simplified and the convenience of using the device is improved.

Specifically, along the flow direction of the gaseous products, temperature intervals of the condensation zones in the condensation chamber 20 are sequentially set at 733 K-713 K, 713 K-693 K, 693 K-673 K, and 673 K-643 K. In this way, silicon and aluminum mainly condense in the condensation zones corresponding to the temperature intervals of 733K-713K and 713K-693K, magnesium condenses in the condensation zone at middle section corresponding to the temperature interval of 693K-673K, and sodium, potassium, and CO primarily condense in the condensation zone at the end section corresponding to the temperature interval of 673K-643K. The use of lower condensation temperatures in combination with the thermal energy of the gaseous products themselves can ensure that different components of the gaseous products condense in different condensation zones within the condensation chamber 20 while enhancing the condensation efficiency and effect of the gaseous products, achieving efficient condensation and purification of magnesium in multiple stages.

Specifically, a thermal insulation component 50 is arranged between the reaction chamber 40 and the condensation chamber 20. Due to the significant difference in temperature requirements between the reaction chamber 40 and the condensation chamber 20, to reduce the impact of heat radiation from the reaction chamber 40 on the condensation chamber 20 and the workload of the second temperature regulation module, the thermal insulation component 50 is employed to separate the reaction chamber 40 and the condensation chamber 20, effectively reducing the heat transferred from the reaction chamber 40 to the condensation chamber 20.

Specifically, the thermal insulation component 50 is a thermal insulation shroud, and the reaction chamber 40 is arranged inside the thermal insulation shroud. To reduce the workload of the first temperature regulation module 70 during the heat preservation reaction while reducing the heat transferred from the reaction chamber 40 to the condensation chamber 20, the thermal insulation component 50 is configured as a thermal insulation shroud to envelop the reaction chamber 40, reducing the heat loss from the reaction chamber 40 and retaining most of the thermal energy within the shroud, thereby assisting in heat preservation of the reaction chamber 40 and effectively reducing the workload of the first temperature regulation module 70 during the heat preservation reaction.

Specifically, a heat preservation layer 60 is arranged inside the thermal insulation shroud. In this way, the loss of thermal energy from the shroud is further reduced, thereby enhancing energy utilization efficiency.

It is to be noted that the heat preservation layer 60 can be made of at least one of organic thermal-insulated heat preservation materials, inorganic thermal-insulated heat preservation materials, and metal thermal-insulated heat preservation materials. In this embodiment, a carbon felt heat preservation layer is preferably used as the heat preservation layer 60.

Specifically, the device also includes a housing 10, and the reaction chamber 40, the condensation chamber 20, and the thermal insulation shroud 50 are arranged inside the housing 10. In this way, the reaction process is protected by the housing 10, minimizing the impact of environmental factors and enhancing the safety of using the device. Additionally, the housing 10 can reduce the heat exchange between the reaction chamber 40, the condensation chamber 20, and the external environment, reduce the workload of the first temperature regulation module 70 and the second temperature regulation module, narrow the temperature fluctuation generated in the reaction chamber 40 and the condensation chamber 20, and promote the stable condensation and purification of magnesium.

Specifically, a plurality of baffle plates 210 are arranged inside the condensation chamber 20, the baffle plates 210 serve for partitioning the condensation chamber 20 into multi-stage condensation zones, and condensation grooves 220 are disposed at tops of the baffle plates 210. When different components of the gaseous products condense in corresponding condensation zones, the condensed products are collected by the condensation grooves 220.

Specifically, the device also includes a cooling system, and the cooling system serves for cooling the reaction chamber 40. At the end of the heat preservation reaction, the cooling system is activated to cool the reaction chamber 40, and cool the reaction chamber 40 and the condensation chamber 20 to room temperature. Subsequently, the air pressure regulation module is controlled to regulate the pressure in the reaction chamber 40 and the condensation chamber 20 to normal pressure, and then the condensed products are collected from the condensation chamber 20.

It is to be noted that the air pressure regulation module serves as a low-pressure gas source, and in this embodiment, a vacuum pump is preferably used as the air pressure regulation module. The first temperature regulation module 70 is an electric heating device, and in this embodiment, an electrically powered graphite heating body is preferably used as the first temperature regulation module 70. In this embodiment, water cooling devices are preferably used as the second temperature regulation module and the cooling system, respectively. Specifically, a first cooling cavity 80 is arranged on an inner wall of the housing 10 corresponding to the condensation chamber 20, and a first heat exchange medium is filled in the first cooling cavity 80. Meanwhile, the first cooling cavity 80 is communicated with a first circulating refrigeration system in a loop manner, allowing the first circulating refrigeration system to cool the first heat exchange medium. The cooled first heat exchange medium is introduced into the first cooling cavity 80 to cool the condensation chamber 20, and then is circulated back to the first circulating refrigeration system for cooling. Similarly, a second cooling cavity 90 is arranged on an inner wall of the housing 10 corresponding to the reaction chamber 40, and a second heat exchange medium is filled in the second cooling cavity 90. Meanwhile, the second cooling cavity 90 is communicated with a second circulating refrigeration system in a loop manner, allowing the second circulating refrigeration system to cool the second heat exchange medium. The cooled second heat exchange medium is introduced into the second cooling cavity 90 to cool the reaction chamber 40, and then is circulated back to the second circulating refrigeration system for cooling.

It is to be noted that water-cooled refrigeration systems are used as the first circulating refrigeration system and the second circulating refrigeration system, and oil or water are used as the first heat exchange medium and the second heat exchange medium.

Specifically, a first liquid outlet 820 is disposed at a top of the first cooling cavity 80, and a first liquid inlet 810 is disposed at a bottom of the first cooling cavity 80. Similarly, a second liquid outlet 920 is disposed at a top of the second cooling cavity 90, and a second liquid inlet 910 is disposed at a bottom of the second cooling cavity 90.

Specifically, the device also includes a temperature detection unit 110. The temperature detection unit 110 serves for detecting the temperature in the condensation zones of the condensation chamber 20 and/or the temperature of the reaction chamber 40. Preferably, the temperature detection unit 110 is a thermocouple. For a structure where the condensation chamber 20 has four condensation zones, five temperature detection units 110 are correspondingly arranged in the device, with four for detecting the temperature of each corresponding condensation zone and one for detecting the temperature of the reaction chamber 40.

Specifically, the gas-guide tube 30 is a conduit, and preferably, the conduit is arranged with a control valve.

### Embodiment 2

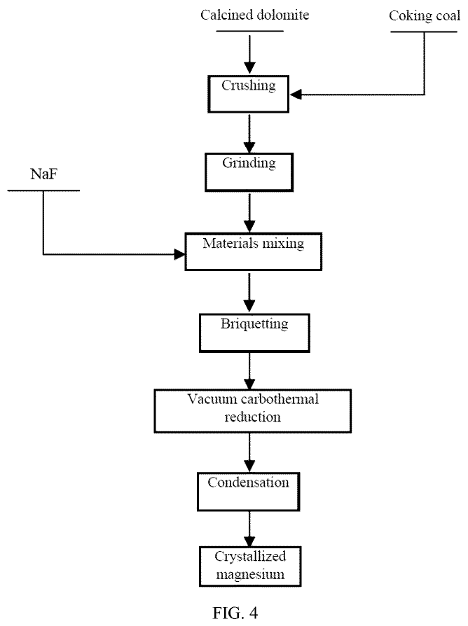

This embodiment of the present application provides a method for magnesium smelting by vacuum carbothermal reduction of calcined dolomite, as shown in FIG. 4. This method is based on the device in Embodiment 1 to smelt magnesium by vacuum carbothermal reduction of calcined dolomite, including the following steps. Calcined dolomite and coking coal crushed and ground to 250 mesh (the calcined dolomite had a MgO mass content of 20.93%, provided by Hebei Xingtai Kaimei New Material Technology Co., Ltd., and the coking coal had a fixed carbon content of >63.58%, produced by Yunnan Shizong Dashe Zhenxing, and the same calcined dolomite and coking coal were used in subsequent embodiments) were divided into eight groups and mixed with the reduction catalyst CaF₂. In the mixtures obtained in eight groups, the calcined dolomite and the coking coal were mixed according to a molar ratio of MgO to C of 1:1.8. The mass percentages of sodium fluoride in the mixtures obtained in eight groups were 0%, 1%, 3%, 5%, 7%, 9%, 11%, and 13%, respectively. After mixing evenly, the mixtures were subjected to briquetting under a pressure of 10 MPa-15 MPa to form blocky materials, enhancing the contact between carbon and magnesium oxide, preventing the blocky materials from becoming loose during the subsequent vacuum, and promoting the solid-solid reaction. Subsequently, the eight groups of briquetted mixtures were separately put into crucibles, and the eight groups of crucibles were placed together in the reaction chamber 40 protected by inert argon gas with a vacuum degree of 70 Pa-120 Pa, for heating to 1473 K-1723 K at a heating rate of 10 K/min-15 K/min, followed by heat preservation reaction at this temperature for 1 h. At high temperatures, the coking coal formed a colloidal body with good thermal stability to encapsulate raw materials. Free F⁻ ions could replace the position of O²⁻ ions to disrupt the surface crystal structure of MgO, causing distortion of MgO crystals, increasing the activity of MgO crystals, promoting the formation of C—O bonds, and enhancing the reduction reaction. During the heat preservation reaction, gaseous products were guided into multi-stage condensation zones within the condensation chamber 20, and the temperature of the condensation chamber 20 was regulated to maintain at 643 K-733 K, achieving dynamic equilibrium of the condensation-based crystallization rate of the gaseous products, the newly entering gaseous products, and the temperature within the condensation chamber 20 during the condensation of the gaseous products in the condensation chamber 20. Along the flow direction of gaseous products, four condensation zones were arranged inside the condensation chamber 20. At the end of the heat preservation reaction, the reaction chamber 40 and the condensation chamber 20 were restored to normal temperature and normal pressure, and the condensed products within a condensation chamber 20 were collected. The products from the third condensation zone from bottom to top were tested, and the purity of the crystallized magnesium was 96.64%. The weight loss rates corresponding to the eight groups of crucibles were 21.5%, 27.0%, 35.8%, 39.2%, 40.0%, 40.4%, 39.0%, and 39.6%, respectively. It can be seen that the addition of calcium fluoride as a catalyst significantly increases the weight loss rate of the raw materials, and improves the reduction degree of the calcined dolomite by vacuum carbothermal reduction for magnesium smelting.

### Embodiment 3

This embodiment of the present application provides a method for magnesium smelting by vacuum carbothermal reduction of calcined dolomite. This method is based on the device in Embodiment 1 to smelt magnesium by vacuum carbothermal reduction of calcined dolomite, including the following steps. Calcined dolomite and coking coal crushed and ground to 250 mesh were divided into eight groups and mixed with the reduction catalyst NaF. In the mixtures obtained in eight groups, the calcined dolomite and the coking coal were mixed according to a molar ratio of MgO to C of 1:1.8. The mass percentages of sodium fluoride in the mixtures obtained in eight groups were 0%, 1%, 3%, 5%, 7%, 9%, 11%, and 13%, respectively. After mixing evenly, the mixtures were subjected to briquetting under a pressure of 10 MPa-15 MPa to form blocky materials. Subsequently, the eight groups of briquetted mixtures were separately put into crucibles, and the eight groups of crucibles were placed together in the reaction chamber 40 protected by inert argon gas with a vacuum degree of 70 Pa-120 Pa, for heating to 1473 K-1723 K at a heating rate of 10 K/min-15 K/min, followed by heat preservation reaction at this temperature for 1 h. During the heat preservation reaction, gaseous products were guided into multi-stage condensation zones within the condensation chamber 20, and the temperature of the condensation chamber 20 was regulated to maintain at 643 K-733 K, achieving dynamic equilibrium in the condensation process of the gaseous products within the condensation chamber 20. Along the flow direction of gaseous products, four condensation zones were arranged inside the condensation chamber 20. At the end of the heat preservation reaction, the reaction chamber 40 and the condensation chamber 20 were restored to normal temperature and normal pressure, and the condensed products within the condensation chamber 20 were collected. The products from a third condensation zone from bottom to top were tested, and the purity of the crystallized magnesium was 95.59%. The weight loss rates corresponding to the eight groups of crucibles were 21.5%, 33.9%, 40.9%, 43.4%, 44.6%, 45.0%, 45.4%, and 46.3%, respectively. It can be seen that the catalytic effect of sodium fluoride as a catalyst in this embodiment is significantly superior to that of the calcium fluoride as a catalyst in Embodiment 2, especially in a case that the addition amount of the catalyst is over 5%.

### Embodiment 4

This embodiment of the present application provides a method for magnesium smelting by vacuum carbothermal reduction of calcined dolomite. This method is based on the device in Embodiment 1 to smelt magnesium by vacuum carbothermal reduction of calcined dolomite, including the following steps. Calcined dolomite and coking coal crushed and ground to 250 mesh were divided into eight groups and mixed with the reduction catalyst NaF. In the mixtures obtained in eight groups, the calcined dolomite and the coking coal were mixed according to a molar ratio of MgO to C of 1:1.8. The mass percentages of sodium fluoride in the mixtures obtained in eight groups were 0%, 1%, 3%, 5%, 7%, 9%, 11%, and 13%, respectively. After mixing evenly, the mixtures were subjected to briquetting under a pressure of 10 MPa-15 MPa to form blocky materials. Subsequently, the eight groups of briquetted mixtures were separately put into crucibles, and the eight groups of crucibles were placed together in the reaction chamber 40 protected by inert argon gas with a vacuum degree of 70 Pa-120 Pa, for heating to 1473 K-1723 K at a heating rate of 10 K/min-15 K/min, followed by heat preservation reaction at this temperature for 2 h. During the heat preservation reaction, gaseous products were guided into multi-stage condensation zones within the condensation chamber 20, and the temperature of the condensation chamber 20 was regulated to maintain at 643 K-733 K, achieving dynamic equilibrium in the condensation process of the gaseous products within the condensation chamber 20. Along the flow direction of gaseous products, four condensation zones were arranged inside the condensation chamber 20. At the end of the heat preservation reaction, the reaction chamber 40 and the condensation chamber 20 were restored to normal temperature and normal pressure, and the condensed products within the condensation chamber 20 were collected. The products from the third condensation zone from bottom to top were tested, and the purity of the crystallized magnesium was 97.78%. The weight loss rates corresponding to the eight groups of crucibles were 30.5%, 37.5%, 44.6%, 46.8%, 48.0%, 48.6%, 49.1%, and 49.8%, respectively. It can be seen that as the addition amount of the catalyst is increased and the heat preservation time is prolonged, the reduction degree of the calcined dolomite by vacuum carbothermal reduction for magnesium smelting is further enhanced.

A control experiment was conducted based on the same experimental conditions as in this embodiment, with the difference that there was only one condensation zone in the condensation chamber 20.

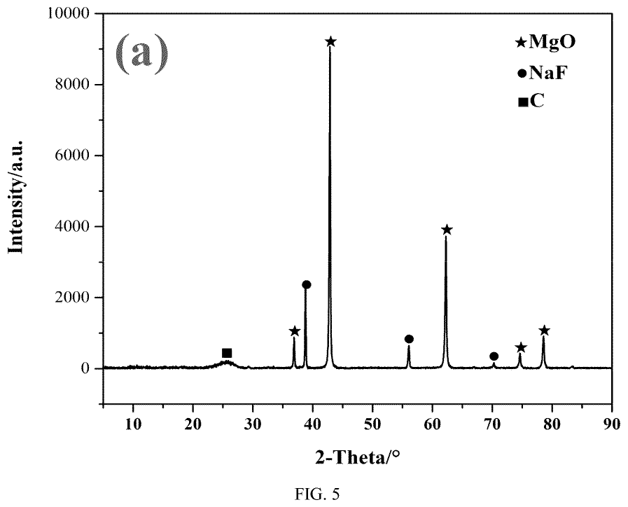

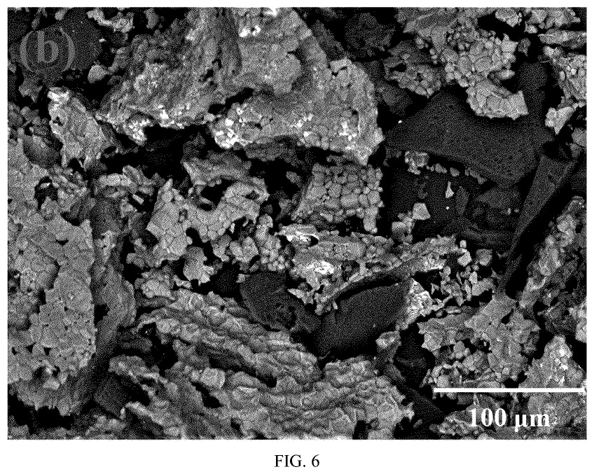

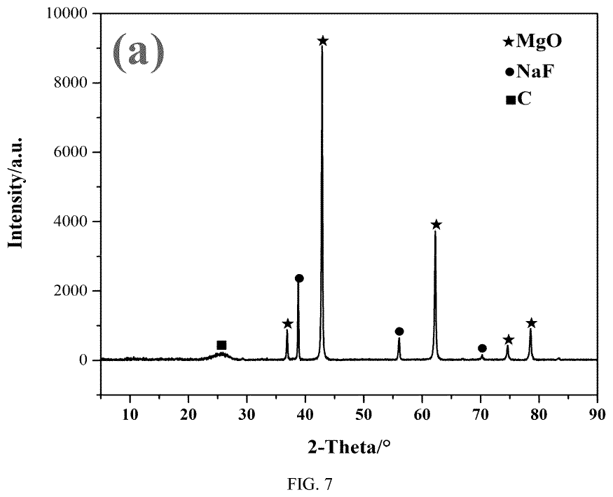

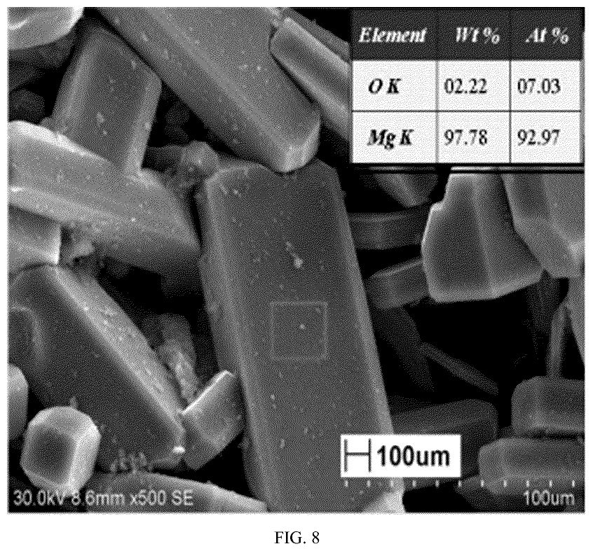

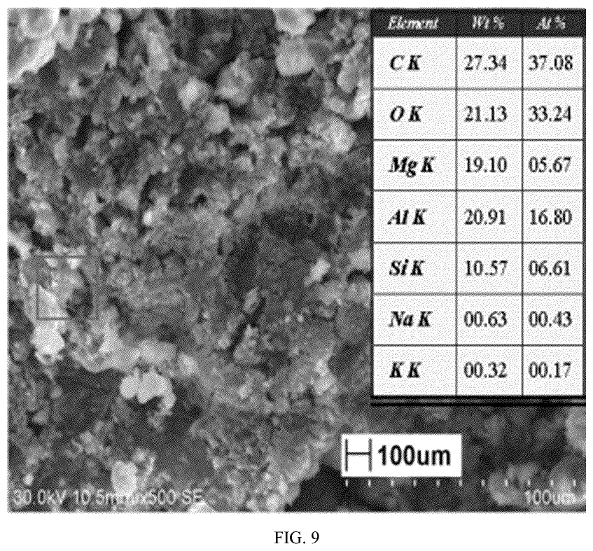

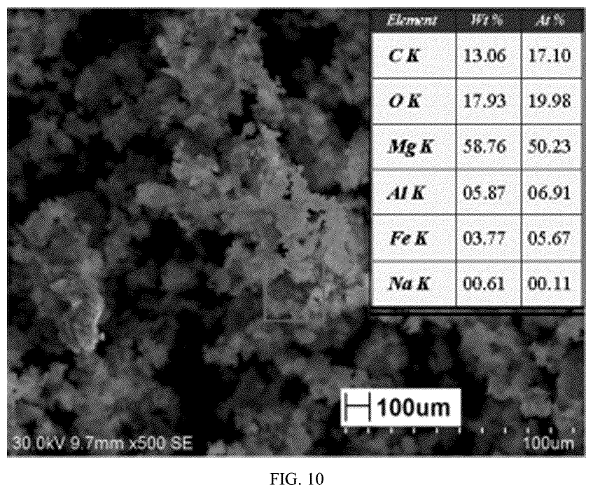

Residues in the reaction chamber 40 of this embodiment were tested by XRD and SEM separately, with test results shown in FIGS. 5 and 6. The condensed products in the third condensation zone from bottom to top within the condensation chamber 20 in this embodiment were tested by XRD and SEM, with test results shown in FIGS. 7 and 8. The condensed products in the fourth condensation zone from the bottom to top within the condensation chamber 20 in this embodiment were tested by SEM, with test results shown in FIG. 9. The condensed products from the condensation chamber 20 in the control experiment were tested by SEM, with test results shown in FIG. 10.

The above described are merely the preferred embodiments of the present disclosure, not used for limiting the present disclosure. Any modifications, equivalent replacements, improvements and the like made within the spirit and principles of the present disclosure are to be included in the scope of protection of the present disclosure.

1. A device for magnesium smelting by vacuum carbothermal reduction of calcined dolomite, comprising a reaction chamber, a condensation chamber, a first temperature regulation module, and an air pressure regulation module, wherein the first temperature regulation module serves for regulating a temperature within the reaction chamber, the air pressure regulation module serves for regulating an air pressure within the reaction chamber, and the reaction chamber is communicated with the condensation chamber via a gas-guide tube; and the gas-guide tube serves for controlling a flow rate of gaseous products from the reaction chamber into the condensation chamber, achieving dynamic equilibrium in the condensation process of the gaseous products within the condensation chamber, and a plurality of condensation zones sequentially communicated along the flow direction of the gaseous products are arranged inside the condensation chamber.

2. The device for magnesium smelting by vacuum carbothermal reduction of calcined dolomite according to claim 1, wherein the device further comprises a second temperature regulation module, the second temperature regulation module serves for regulating a temperature within the condensation chamber, and the second temperature regulation module is cooperated with the gas-guide tube to realize dynamic equilibrium in the condensation process of the gaseous products within the condensation chamber.

3. The device for magnesium smelting by vacuum carbothermal reduction of calcined dolomite according to claim 1, wherein the condensation chamber is arranged above the reaction chamber.

4. The device for magnesium smelting by vacuum carbothermal reduction of calcined dolomite according to claim 3, wherein the condensation zones in the condensation chamber are arranged longitudinally and sequentially.

5. The device for magnesium smelting by vacuum carbothermal reduction of calcined dolomite according to claim 1, wherein a thermal insulation component is arranged between the reaction chamber and the condensation chamber.

6. The device for magnesium smelting by vacuum carbothermal reduction of calcined dolomite according to claim 5, wherein the thermal insulation component is a thermal insulation shroud, and the reaction chamber is arranged inside the thermal insulation shroud.

7. The device for magnesium smelting by vacuum carbothermal reduction of calcined dolomite according to claim 6, wherein the device further comprises a housing, and the reaction chamber, the condensation chamber, and the thermal insulation shroud are arranged inside the housing.

8. The device for magnesium smelting by vacuum carbothermal reduction of calcined dolomite according to claim 1, wherein a plurality of baffle plates are arranged inside the condensation chamber, the baffle plates serve for partitioning the condensation chamber into multi-stage condensation zones, and condensation grooves are disposed at tops of the baffle plates.

9. The device for magnesium smelting by vacuum carbothermal reduction of calcined dolomite according to claim 2, wherein a plurality of baffle plates are arranged inside the condensation chamber, the baffle plates serve for partitioning the condensation chamber into multi-stage condensation zones, and condensation grooves are disposed at tops of the baffle plates.

10. The device for magnesium smelting by vacuum carbothermal reduction of calcined dolomite according to claim 3, wherein a plurality of baffle plates are arranged inside the condensation chamber, the baffle plates serve for partitioning the condensation chamber into multi-stage condensation zones, and condensation grooves are disposed at tops of the baffle plates.

11. The device for magnesium smelting by vacuum carbothermal reduction of calcined dolomite according to claim 4, wherein a plurality of baffle plates are arranged inside the condensation chamber, the baffle plates serve for partitioning the condensation chamber into multi-stage condensation zones, and condensation grooves are disposed at tops of the baffle plates.

12. The device for magnesium smelting by vacuum carbothermal reduction of calcined dolomite according to claim 1, wherein the device further comprises a cooling system, and the cooling system serves for cooling the reaction chamber.

13. The device for magnesium smelting by vacuum carbothermal reduction of calcined dolomite according to claim 2, wherein the device further comprises a cooling system, and the cooling system serves for cooling the reaction chamber.

14. The device for magnesium smelting by vacuum carbothermal reduction of calcined dolomite according to claim 3, wherein the device further comprises a cooling system, and the cooling system serves for cooling the reaction chamber.

15. The device for magnesium smelting by vacuum carbothermal reduction of calcined dolomite according to claim 4, wherein the device further comprises a cooling system, and the cooling system serves for cooling the reaction chamber.

16. A method for magnesium smelting by vacuum carbothermal reduction of calcined dolomite, based on the device for magnesium smelting by vacuum carbothermal reduction of calcined dolomite according to claim 1, comprising the following steps: mixing calcined dolomite, coking coal, and a reduction catalyst, followed by briquetting, and placing a briquetted mixture in the reaction chamber under inert gas protection and a vacuum degree of 120 Pa or below, followed by heat preservation reaction at 1473 K-1723 K, wherein during the heat preservation reaction, the gaseous products are guided into the multi-stage condensation zones within the condensation chamber, and the temperature of the condensation chamber is regulated to maintain at 643 K-733 K, achieving dynamic equilibrium in the condensation process of the gaseous products within the condensation chamber; and along the flow direction of the gaseous products, temperatures of the multi-stage condensation zones within the condensation chamber gradually decrease.

17. A method for magnesium smelting by vacuum carbothermal reduction of calcined dolomite, based on the device for magnesium smelting by vacuum carbothermal reduction of calcined dolomite according to claim 2, comprising the following steps: mixing calcined dolomite, coking coal, and a reduction catalyst, followed by briquetting, and placing a briquetted mixture in the reaction chamber under inert gas protection and a vacuum degree of 120 Pa or below, followed by heat preservation reaction at 1473 K-1723 K, wherein during the heat preservation reaction, the gaseous products are guided into the multi-stage condensation zones within the condensation chamber, and the temperature of the condensation chamber is regulated to maintain at 643 K-733 K, achieving dynamic equilibrium in the condensation process of the gaseous products within the condensation chamber; and along the flow direction of the gaseous products, temperatures of the multi-stage condensation zones within the condensation chamber gradually decrease.

18. A method for magnesium smelting by vacuum carbothermal reduction of calcined dolomite, based on the device for magnesium smelting by vacuum carbothermal reduction of calcined dolomite according to claim 3, comprising the following steps: mixing calcined dolomite, coking coal, and a reduction catalyst, followed by briquetting, and placing a briquetted mixture in the reaction chamber under inert gas protection and a vacuum degree of 120 Pa or below, followed by heat preservation reaction at 1473 K-1723 K, wherein during the heat preservation reaction, the gaseous products are guided into the multi-stage condensation zones within the condensation chamber, and the temperature of the condensation chamber is regulated to maintain at 643 K-733 K, achieving dynamic equilibrium in the condensation process of the gaseous products within the condensation chamber; and along the flow direction of the gaseous products, temperatures of the multi-stage condensation zones within the condensation chamber gradually decrease.

19. A method for magnesium smelting by vacuum carbothermal reduction of calcined dolomite, based on the device for magnesium smelting by vacuum carbothermal reduction of calcined dolomite according to claim 4, comprising the following steps: mixing calcined dolomite, coking coal, and a reduction catalyst, followed by briquetting, and placing a briquetted mixture in the reaction chamber under inert gas protection and a vacuum degree of 120 Pa or below, followed by heat preservation reaction at 1473 K-1723 K, wherein during the heat preservation reaction, the gaseous products are guided into the multi-stage condensation zones within the condensation chamber, and the temperature of the condensation chamber is regulated to maintain at 643 K-733 K, achieving dynamic equilibrium in the condensation process of the gaseous products within the condensation chamber; and along the flow direction of the gaseous products, temperatures of the multi-stage condensation zones within the condensation chamber gradually decrease.

20. A method for magnesium smelting by vacuum carbothermal reduction of calcined dolomite, based on the device for magnesium smelting by vacuum carbothermal reduction of calcined dolomite according to claim 5, comprising the following steps: mixing calcined dolomite, coking coal, and a reduction catalyst, followed by briquetting, and placing a briquetted mixture in the reaction chamber under inert gas protection and a vacuum degree of 120 Pa or below, followed by heat preservation reaction at 1473 K-1723 K, wherein during the heat preservation reaction, the gaseous products are guided into the multi-stage condensation zones within the condensation chamber, and the temperature of the condensation chamber is regulated to maintain at 643 K-733 K, achieving dynamic equilibrium in the condensation process of the gaseous products within the condensation chamber; and along the flow direction of the gaseous products, temperatures of the multi-stage condensation zones within the condensation chamber gradually decrease.
